(19) United States
(12) Patent Application Publication
(10) Pub. No.: US 2007/0194539 A1
(43) Pub. Date: Aug. 23, 2007

(54) Sealing, trimming or guiding strips

(76) Inventors: Peter Titz, Monchengladbach (DE); Heinz Andrzejewski, Andreasstrasse (DE)

Correspondence Address: LEYDIG VOIT & MAYER, LTD, 700 THIRTEENTH ST. NW, SUITE 300, WASHINGTON, DC, 20005-3960, US

(21) Appl. No.: 10/529,929

(22) PCT Filed: Oct. 2, 2003
(86) PCT No.: PCT/IB03/04357

§ 371 Date: Jan. 22, 2007

(30) Foreign Application Priority Data
Oct. 2, 2002 (GB) 0222816.1

(51) Int. Cl. B29C 47/00; B29C 65/00; B32B 37/12; B32B 38/00; F16J 15/14

(52) U.S. Cl. 277/590; 156/245; 156/304.3; 156/304.5; 156/244.11

(57) ABSTRACT

A sealing, trimming or guiding strip comprises a first section having an extruded portion (19) which defines a channel for mounting on a vehicle window frame and has extending therefrom a flocked lip (53). A second section of the strip is provided which also comprises an extruded portion defining a channel for mounting on the frame and which has extending therefrom a flocked lip (76). The two sections are abutted and selected parts (for example, non-flocked parts) of the respective sections are joined together by a moulding operation which forms a flap (20) of moulded material extending between the respective sections. The heat from die moulding process activates a heat-activatable material applied to at least one of the flocked lips (53 and 70) at the surface where the respective lips abut at (17). The heat generated by the moulding process is sufficient to activate the heat-activatable material but does not damage the flocked material of the lips (53 and 76).

### FIELD OF THE INVENTION

The invention relates to sealing, trimming or guiding strips and methods of making them. Embodiments of the invention, to be described in more detail below, are window sealing, trimming and guiding strip assemblies for use in motor vehicle body construction and, in particular, for use in window frames forming the upper part of vehicle doors, the sealing or guiding strip assembly being attached to the window frame and supporting the edge of a window pane which can be raised from and lowered into the lower part of the door. However, the invention is not restricted to such applications.

### BRIEF SUMMARY OF THE INVENTION

According to the invention, there is provided a method of forming a sealing, trimming or guiding strip for a window frame, including providing first and second sections of the strip, joining at least one part of the first section to at least one part of the second section by applying and activating a heat-activatable material and joining other parts of the respective first and second sections by a moulding operation.

According to the invention, there is further provided a method of forming a sealing, trimming or guiding strip for a window frame, including providing first and second sections of the strip, each having at least one part for contacting a window mounted in the frame; applying heat-activatable material to at least one of said parts; abutting the first and second sections of the strip; moulding together the first and second sections except for said parts, the said parts of the respective first and second sections being joined by activation of the heat-activatable material.

According to the invention, there is also provided a method of forming a sealing, trimming or guiding strip for a window frame, including forming first and second sections of the strip by a continuous extrusion process; providing a part of each of the strips with a flocked surface; applying heat-activatable material to at least one of the parts having one of the flocked surfaces; providing a mould and heating means for heating the mould; and positioning the first and second sections of the strip with respect to the mould such that a portion of the first and second sections of the strip extend into a mould cavity and are heated to a relatively high temperature to connect the portions of the strip extending into said cavity by moulding, and the respective parts with the flocked surfaces abut each other and are heated to a relatively low temperature to activate the heat-activatable material such that the parts having the flocked surfaces are also joined.

According to the invention, there is further provided a sealing, trimming or guiding strip for mounting on a window frame, including first and second sections of the strip, wherein at least one part of the respective first and second sections has a heat activatable material applied thereto to join it to a corresponding part of the other of the respective first and second sections, and wherein the other parts are joined by moulded material.

### BRIEF DESCRIPTION OF THE DRAWINGS

Sealing, trimming or guiding strips for vehicles, and methods for making such strips, embodying the invention will now be described, by way of example only, with reference to the accompanying diagrammatic drawings in which:

FIG. 1 is a side view of a motor vehicle with the top corner of the B pillar encircled;

FIG. 2 shows an enlarged view of the encircled region of FIG. 1;

FIG. 3 shows a cross-sectional view taken along the line A-A of FIG. 2;

FIG. 4 shows a cross-sectional view taken along the line B-B of FIG. 2;

FIG. 5 shows a perspective view of the strip of FIG. 3, which is mitre cut prior to attachment to the strip of FIG. 4;

FIG. 6 shows a perspective view of the strip of FIG. 4 which is mitre cut prior to attachment to the strip of FIG. 3.

In general, in the drawings, like elements are designated with the same reference numeral.

### DETAILED DESCRIPTION OF AN EMBODIMENT OF THE INVENTION

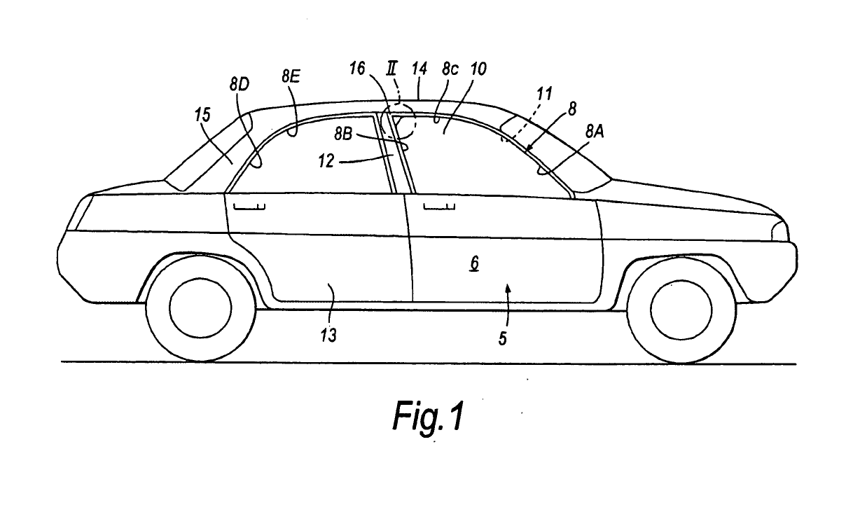

FIG. 1 shows the side of a motor vehicle body having a door 5 with a lower part 6 carrying a window frame indicated diagrammatically at 8 for a window opening 10. In the usual way, a window glass for the opening 10 can be raised from and lowered into the lower part 6 of the door. The frame 8 carries the sealing and guiding strip (not visible in FIG. 1) which will be described in more detail below.

The frame 8 comprises a part 8A along the sloping front of the front door 5 which is alongside the so-called “A” pillar of the vehicle body, a generally vertical part 8B alongside the so-called “B” pillar 12 of the vehicle body, and a part 8C running along the top of the door 5.

Where the “B” pillar 12 meets the roof 14 of the vehicle, a sharp angle (substantially 90°) is formed, at 16. In a manner to be explained below, the sealing and guiding strip assembly to be described combines with the frame 8 to form a corresponding sharp angle.

The frame 8 further comprises a part 8D along the sloping rear of the rear door 13 which is alongside the so-called “C” pillar 15 of the vehicle body, and a part 8E running along the top of the rear door 15.

It should be appreciated that the strip of the present invention is not only for forming sharp angles. For example, the strip could be employed where the “C” pillar 15 meets the roof 14 of the vehicle, where a relatively shallow angle is formed.

The frame 8 carried by the door 5 is (in this example) made of metal, such as extruded aluminium.

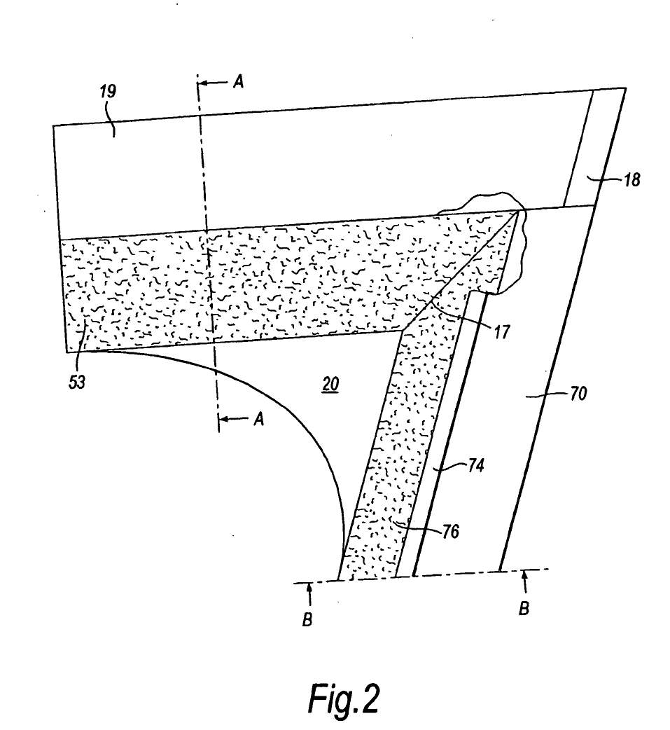

FIG. 2 shows an enlarged view of the sharp corner 16 of the window frame 8 of the door 5, where the frame part 8B meets the frame part 8C in the encircled region II. At the corner of the sealing strip two separate lengths of strip material meet and are joined at the point indicated by line 17. The first length of strip material, which runs generally parallel to the roof 14, includes extruded parts 19 and 53, the part 53 having a flocked surface. At the sharp corner an end cap 18 is fitted to the end of the extruded part 19 to provide a neat appearance.

The part of the strip which runs parallel to the B pillar 12 comprises an outer rigid layer 70 which overlies extruded material, which is integrally formed with flocked lips 74 and 76. A flap of material 20 bridges the sharp corner. The flap 20 is formed by moulding.

The structure of the elements shown in FIG. 2 will be understood further by the following description of the cross-sections taken along lines A-A and B-B.

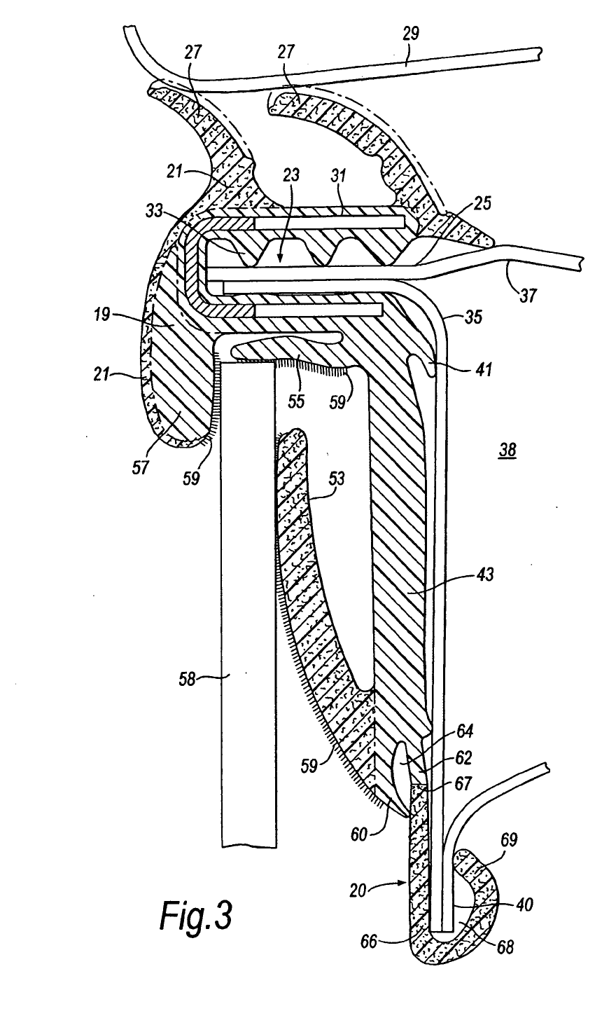

FIG. 3 shows a cross-section through the strip at the region above the window opening 10 (along line A-A of FIG. 2). The continuously extruded part 19 forms the outer face of the strip, which is visible from the exterior of the vehicle. The continuously extruded part 19 is formed with regions 21 that are of relatively soft material—as indicated by relatively closely-spaced hatching lines. The inner side of the strip defines a channel 23 which embraces a flange 25 formed by inner and outer panels 35,37 of the window frame 8. The uppermost exterior surface of the channel 23 carries integral resiliently deformable lips 27 which press against a bodywork panel 29 defining the opening for the door 5. The bodywork 29 extends along the top of the door opening, substantially parallel to the roof 14 of the vehicle.

A channel-shaped reinforcing carrier 31 is integrally embedded within the continuously extruded part 19 during the extrusion process. The reinforcing carrier 31 may be made of metal and may be slotted or slitted to improve its flexibility. For example, it may comprise U-shaped elements arranged next to each other to define a channel, the elements being either integrally connected together by short flexible connecting links or perhaps entirely disconnected from each other. Looped wire may be used instead. Other forms of carrier can also be used.

The continuously extruded part 19 is extruded to provide integral resiliently deformable lips 33 within the channel 23 which help to hold the strip securely in position on the flange 25.

The inner and outer panels 35,37 forming the frame of the window are spot-welded (or otherwise attached together) to form the flange 25, then diverge to form a hollow space 38 and come together again to form a further flange 40 where they are again spot-welded (or attached by some other means).

Extended from (and integrally extruded with) the lower side of the channel 23 is a limb 43. At the end of the limb 43 the extruded material divides into a first member 60, from which the lip 53 extends, and a second member 62, leaving a space 64 therebetween. A moulded part 66 is moulded onto the second member 62 at the join 67 in a process to be described in greater detail below. The moulded part 66 defines a further channel 68 by means of lip 69. The channel 68 accommodates and resiliently embraces the flange 40. The outwardly facing surface of the moulded part 66 forms the flap 20 (FIG. 2).

The continuously extruded part 19 of the strip 15 includes an additional lip 41 which engages the panel 35.

The limb 43 further carries a lip 57 extending towards the lip 53 and formed integrally with the extruded material defining the channel 23. Lips 53 and 57 together form a channel or recess for receiving the edge of the window pane 58 of the window opening 10. Lip 53 contacts the inside surface of the window pane 58 when the window is closed. Lip 57 contacts the outer surface of the window pane 58. A further lip 55 engages the top edge of the window pane 58. Each of the lips 53,55 and 57 may be provided with a coating of flocked material 59 at the point where they engage the glass window pane 58. The lip 53 may not be visible from the exterior of the vehicle. Its upper part will be obscured by the continuously extruded part 19, and may further be obscured by a black shading applied to the upper part of the window pane 58 when the window is closed.

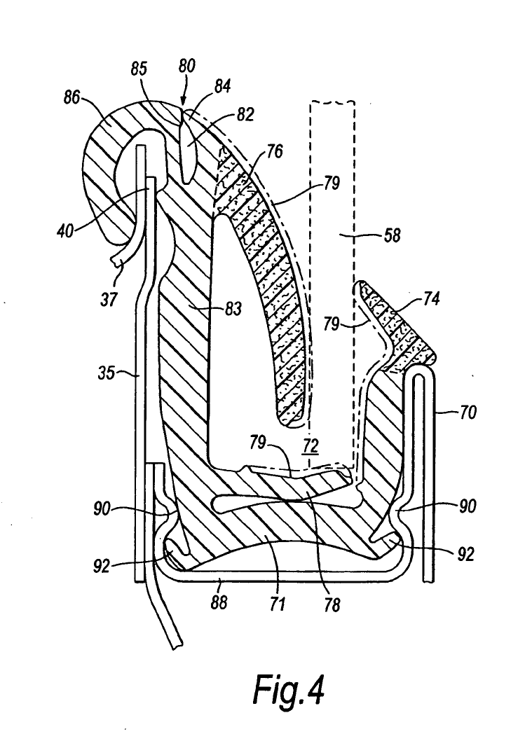

FIG. 4 shows a cross-section taken through the strip along the line B-B of FIG. 2. A continuously extruded part 71 forms a channel 72 for receiving the glass pane 58. The mouth of the channel 72 at the shorter side thereof terminates in an integrally formed outwardly extending lip 74. At the longer side of the mouth, the channel terminates in a relatively longer integrally formed inwardly directed lip 76. A further lip 78 extends across and lies substantially parallel to the base of the channel 72, for pressing against the glass pane 58. The surfaces 79 of each of the lips 74,76 and 78 are preferably coated with flocked material.

At the distal end of a limb 83 of the extruded part 71 from which the lip 76 extends, the extruded material is formed with a split 80 which forms a cavity 82 within the extruded material. The distal end of the cavity 82 is closed by an integrally extruded lip 84. A further lip 86 extends from a member 85 on the opposite side of the cavity to the flocked lip 76, the lip 86 extending around and resiliently embracing the flange 40 of the window frame 8.

The extruded part 71 is accommodated within a rigid division bar 88, which may for example be formed of metal. The outer rigid layer 70 (FIG. 2) is part of the division bar 88. The base portion of the extruded material 71 is pressed into the division bar 88 and is held in position by ridges 90 which cooperate with securing lips 92 extending from the exterior surface of the base of the extruded part 71. The division bar 88 may be formed by folding a single sheet of metal to form the desired shape. The division bar 88 may accommodate a further sealing assembly for providing sealing between the door frame 8 and the car main body. This is not illustrated and will not be further described as the present invention is not concerned with such arrangements.

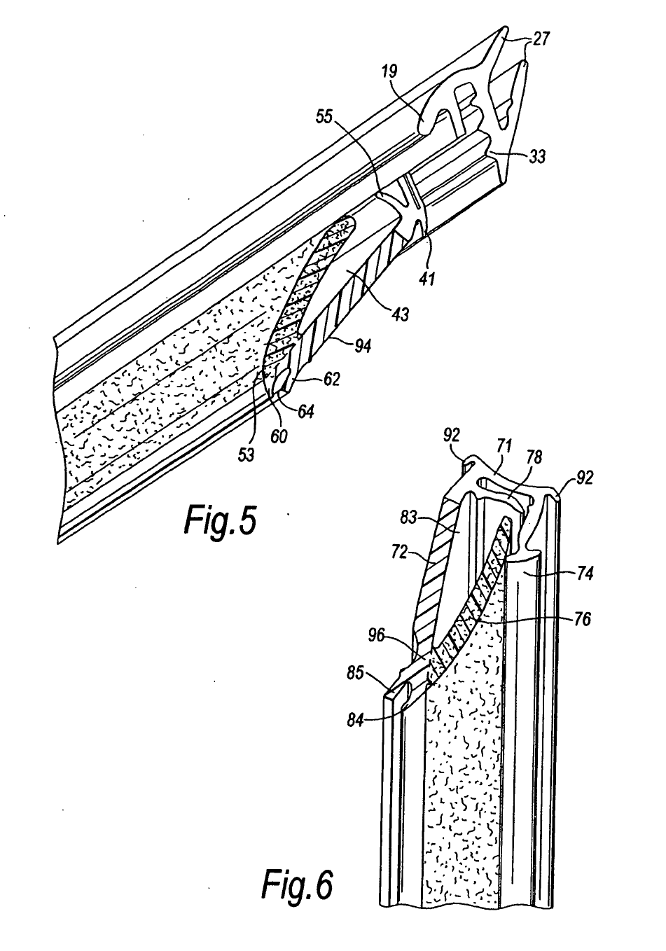

FIGS. 5 and 6 show respectively perspective views of the two strip parts prior to connecting those parts to form the sharp corner.

At the corner 16 of the window frame 8 the two lengths of the sealing strip are joined together to match the corner, as indicated in FIG. 2. More specifically, the two lengths of sealing strip and are mitre-cut and then joined together along the line 17. In addition, and as will be described in more detail below, a moulding operation is carried out to form the flexible corner piece 20 from rubber or other suitable material, the corner piece 20 being attached to and extending from the second member 62 of the extruded part 19 and the member 85 of extruded part 71. The corner piece 20 has a shape which generally matches, and thus in use covers a curved part of the frame where part 8B meets part 8C (FIG. 1).

As indicated above, the corner piece 20 is produced by a moulding operation. The surfaces 94 and 96 (FIGS. 5 and 6) exposed by cutting are painted with a heat-activated adhesive or a heat-activated film layer is applied to the surfaces 94 and 96. The two lengths of strip to be joined at the corner are placed adjacent a mould (not shown), with the members 62 and 85 extending into the mould. The mould has a cavity matching the shape of the corner piece 20 and into which material is forced and heated to form to the corner piece 20 and to mould the corner piece 20 onto members 62 and 85. This form of construction enables the corner piece 20 to be produced by a moulding operation which avoids the application of excessive heat to the sealing strip and, in particular, to the flock on the surface of the lips 53 and 76. However, the moulding operation generates sufficient heat to activate the heat-activatable material applied to the surfaces 94 and 96. The flocked lips 53 and 76 are joined by heat generated by the moulding process. No additional joining step is required.

The mould cavity in which the corner piece 20 is moulded is formed by an upper mould plate (not shown) which passes into the cavity 64 shown in FIG. 3, which pushes the first member 60 away from the second member 62. The lower mould plate (also not shown) is positioned below the upper mould plate, and together the two mould plates are shaped to define the cavity matching the required shape of the corner piece 20. During the moulding operation, heat is applied to form the moulding material in the mould cavity into the desired shape for the corner piece 20, but the upper mould plate protects the flock on the lips 53 and 76 against being damaged by this heat. However, the heat is sufficient to activate the heat activatable material applied to surfaces 94 and 96. This process therefore enables the corner piece to be moulded onto already-flocked lengths of the sealing strip.

Where the flocked surfaces of the lips 53,76 join at 17 there is a very small gap in the flock. This gap is less than 2 mm, and may be less than 1 mm. Prior art fabrication techniques have produced a gap between 2 and 3 mm. The smaller gap increases the effectiveness of the flocked material and provides a more pleasing visual appearance.

It should be understood that the invention is applicable to connecting sealing, trimming or guiding strips in general, and is not restricted to the joining of such strips only at sharp corners.

The moulded part may be formed, for example, from EPD or TPE.

As mentioned above, the surfaces 94 and 96 of the limbs 43,83 and the lips 53,76 are coated with a heat activatable material to join them, and the members 62 and 85 are joined by moulding. The other parts of the two lengths of sealing strip which are brought together—including lips 33,41,55,57,74,78 and 92—can be joined either by applying heat activatable adhesive to the facing surfaces of these parts, or by moulding them together (either in a separate moulding operation to the moulding operation to join members 62 and 85, or, preferably, in the same moulding operation that joins members 62 and 85—the moulded parts extending into the mould cavity).

Preferably, the parts that are secured by the heat activatable adhesive are the lips 53,55,57,74,76,78 and the limbs 43,72—these being parts that support or contact the glass pane 58.

The parts that are to be joined by heat activatable adhesive may lie outside the mould cavity. This is advantageous if these parts have a flocked coating because the heat within the mould may damage the flock.

Alternatively, the parts joined by heat activatable material (including the surfaces 94 and 96 of the limbs 43,83 and the lips 53,76) may be located within the mould cavity. If desired, these parts (or selected ones of the parts) can be cooled during the moulding process—for example by a supply of cooling water.

1. A method of forming a sealing, trimming or guiding strip for a window frame, the method comprising the steps of:
providing first and second sections of the strip,
joining at least one part of the first section to at least one part of the second section by applying and activating a heat-activatable material, and
joining other parts of the respective first and second sections by a molding operation.

2. The method according to claim 1, wherein said at least one parts of the first and second sections comprise a flocked surface.

3. The method according to claim 1, wherein said other parts of the first and second sections comprise non-flocked surfaces.

4. The method according to claim 1, wherein said at least one parts of the first and second sections are positioned for supporting or contacting a window pane mounted in the window frame.

5. The method according to claim 1, wherein the first and second sections meet to form a corner.

6. The method according to claim 5, wherein the corner forms an angle of substantially 90°.

7. The method according to claims 1, wherein the molding operation forms a flap extending between the first and second sections.

8. The method according to claim 7, wherein the flap is formed to obscure a corner of the window frame.

9. The method according to 1, wherein the heat-activatable material is activated by the heat generated by the molding step.

10. The method according to 1, further comprising the step of forming the first and second sections of the strip by extrusion.

11. The method according to claims 1, wherein each of the first and second sections includes a channel portion for mounting on a flange of the window frame.

12. The method according to claim 11, wherein said at least one parts of the first and second sections comprise a flocked lip for pressing against a window pane and a limb extending from the channel portion, the lip extending from a distal end of the limb.

13. The method according to claim 12, wherein said other parts have the non-flocked surfaces extending from the distal end of the limb.

14. A method of forming a sealing, trimming or guiding strip for a window frame, the method including:
providing first and second sections of the strip, each section having at least one part for contacting a window mounted in the frame;
applying heat-activatable material to at least one of said parts; abutting the first and second sections of the strip; and
molding together the first and second sections except for said parts, said parts of the respective first and second sections being joined by activation of the heat-activatable material.

15. The method according to claim 14, wherein said parts have flocked surfaces.

16. The method according to claim 14, wherein the heat-activatable material is activated by heat generated by the molding step.

17. A method of forming a sealing, trimming or guiding strip for a window frame, the method including:
forming first and second sections of the strip by a continuous extrusion process;
providing a part of each of the strips with a flocked surface;
applying heat-activatable material to at least one of the parts having the flocked surfaces;
providing a mold having a mold cavity and heating means for heating the mold cavity; and
positioning the first and second sections of the strip with respect to the mold such that a portion of the first and second sections of the strip extend into the mold cavity and are heated to a relatively high temperature to connect the portions of the strip extending into said cavity by molding, and the respective parts with the flocked surfaces abut each other and are heated to a relatively low temperature to activate the heat-activatable material such that the parts having the flocked surfaces are also joined.

18. The method according to claim 17, wherein the respective parts with the flocked surfaces lie outside of the mold cavity and are heated indirectly by the heating of the mold cavity.

19. The method according to claim 17, wherein the respective parts with the flocked surfaces are positioned within the mold cavity and are cooled.

20. The method according to claim 17, wherein the respective sections meet to form a corner.

21. The method according to of claims 17, wherein the mold cavity forms a flap of molded material which connects the first and second sections of the strip, said flap being shaped and positioned to obscure a corner of the window frame.

22. The method according to claims 17, wherein the heat activatable adhesive is activated by heat generated from the molding step.

23. The method according to of claims 17, wherein each of the first and second sections include a channel portion for mounting on a flange of the window frame, a limb extending from the channel, a flocked lip extending from the distal end of the limb for pressing against a window pane, the flocked lip comprising the part with the flocked surface, and a non-flocked part extending from the distal end of the limb.

24. A sealing, trimming or guiding strip for mounting on a window frame, comprising first and second sections of the strip, wherein at least one part of the respective first and second sections has a heat activatable material applied thereto to join it to a corresponding part of the other of the respective first and second sections, and wherein other parts of the first and second sections are joined by molded material.

25. The strip of claim 24, wherein each of said at least one part of the respective first and second sections has a flocked surface.

26. The strip of claim 24, wherein said other parts of the respective first and second sections each have non-flocked surfaces.

27. The strip of claim 24, wherein said at least one part of the respective first and second sections is adapted to supporting or contact a window pane mounted in the window frame.

28. The strip of claims 24, wherein the first and second sections of the strip meet to form a corner.

29. The strip of claim 28, wherein the corner forms an angle of substantially 90°.

30. The strip of claims 24, wherein the molded material forms a flap extending between the first and second sections of the strip.

31. The strip of claim 30, wherein the flap is formed to obscure a corner of the window frame.

32. The strip of claims 24, wherein the heat-activated material is positioned so as to be activated by the formation of molded material.

33. The strip of claims 24, wherein the first and second sections of the strip comprise extruded material.

34. The strip of claims 24, wherein the first and second sections include a channel portion for mounting on a flange of the window frame.

35. The strip of claim 34, wherein each said at least one comprises a flocked lip for pressing against a window pane and a limb extending from the channel portion, the lip extending from a distal end of the limb.

36. The strip of claim 35, wherein said other parts have non-flocked surfaces extending from the distal end of the limb.
